(19) United States
(12) Patent Application Publication
(10) Pub. No.: US 2014/0370258 A1
(43) Pub. Date: Dec. 18, 2014

(54) ELECTRODE MATERIAL, SPARK-PLUG ELECTRODE, AND SPARK PLUG

(71) Applicant: SUMITOMO ELECTRIC INDUSTRIES, LTD., Osaka-shi, Osaka (JP)

(72) Inventors: Hajime Ota, Osaka-shi (JP); Taichiro Nishikawa, Osaka-shi (JP); Masao Sakuta, Neyagawa-shi (JP); Kazuo Yamazaki, Neyagawa-shi (JP); Takeshi Tokuda, Neyagawa-shi (JP); Shin Tomita, Neyagawa-shi (JP); Yoshiyuki Takaki, Osaka-shi (JP)

(21) Appl. No.: 14/375,572

(22) PCT Filed: Dec. 27, 2012
(86) PCT No.: PCT/JP2012/083774

§ 371 Date: Jul. 30, 2014

(30) Foreign Application Priority Data
Feb. 3, 2012 (JP) 2012-022307
Jun. 27, 2012 (JP) 2012-144429
Aug. 31, 2012 (JP) 2012-192382

(51) Int. Cl. H01T 13/39; C22C 19/05; F02P 15/00

(52) U.S. Cl. CPC H01T 13/39; F02P 15/00; C22C 19/05
USPC 428/216; 420/443

(57) ABSTRACT

An electrode material contains, on a mass percent basis, Al: 0.005% to 0.2%, Si: 0.2% to 1.6%, Cr: 0.05% to 1.0%, Ti: 0.05% to 0.5%, and Y: 0.2% to 1.0%. The remainder are Ni and inevitable impurities. The Si/Cr mass ratio is 1 or more. Because of the inclusion of specific amounts of Al, Si, Cr, and Y and the Si content higher than the Al content, the electrode material has an oxidation inhibiting effect. The inclusion of the specific amount of Ti can reduce the occurrence of expansion and cracking of the oxide film. Because of the inclusion of the specific amount of Y, the oxide film can maintain the microstructure even at high temperatures and have high resistance to high-temperature oxidation. Having a Si/Cr ratio of 1 or more, the oxide film has improved corrosion resistance and is resistant to corrosion by corrosive liquids.

### TECHNICAL FIELD

The present invention relates to an electrode material that can be used as a material of a spark-plug electrode in internal combustion engines, for example, for automobiles, a spark-plug electrode made of the electrode material, and a spark plug including the electrode. More particularly, the present invention relates to an anti-corrosive spark-plug electrode that is resistant to high-temperature oxidation and resistant to corrosion by aqueous solutions and an electrode material suitable for a material of the electrode.

### BACKGROUND ART

Spark plugs are used for the ignition of internal combustion engines, such as automotive gasoline engines. Typically, spark plugs include a rod-like center electrode and a ground electrode, which is separated from the center electrode and faces an end face of the center electrode. A gas containing fuel flowing between the center electrode and the ground electrode is ignited by a spark discharge between these electrodes.

Patent Literature 1 discloses a nickel alloy containing Al, Si, Cr, Mn, and Y as the electrode material.

### CITATION LIST

### Patent Literature

PTL 1: Japanese Patent No. 4295501

### SUMMARY OF INVENTION

### Technical Problem

The characteristics required for spark-plug electrodes include resistance to oxidation (in particular, resistance to oxidation at high temperatures), resistance to erosion by sparks (resistance to spark erosion), and resistance to the formation of compound particles containing nickel on the electrode surface (resistance to sweating; the details of the compound particles are described below). The electrode material described in Patent Literature 1 includes the elements described above to satisfy these requirements.

In recent years, there has been a demand for improved fuel efficiency of automobiles as an environmental conservation measure. For example, the fuel efficiency can be improved by further increasing the combustion temperature of internal combustion engines or performing exhaust gas recirculation (EGR). With a further increase in combustion temperature, spark-plug electrodes are used in still higher temperature environments. The maximum combustion temperature of gasoline engines in existing general automobiles ranges from approximately 900° C. to 1000° C. An increase in combustion temperature results in approximately +100° C. higher temperature environments, for example. Thus, recent operating environments of spark plugs are becoming more oxidizing due to much higher temperatures than before. It is therefore desirable to further improve the resistance to high-temperature oxidation of spark-plug electrode materials.

For example, an increase in amounts of additive elements, such as Al, can enhance the oxidation inhibiting effect. An increase in amounts of additive elements, however, results in an increased specific resistance, which accelerates spark erosion, resulting in low resistance to spark erosion. Thus, there is a limit to the improvement in characteristics due to an increase in amounts of additive elements, such as Al.

Furthermore, during the operation of a spark plug, Al may react with nitrogen in the atmosphere and form a nitride thereof (AlN), which may promote oxidation. When an electrode made of a nickel alloy is used in a spark plug, an oxide film may be formed on the surface of the electrode over time, depending on the composition of the nickel alloy or the operating conditions. The oxide film can partly prevent the oxidation of the nickel alloy base material inside the oxide film. However, the nitride in the oxide film tends to cause a crack in the oxide film or separation of the oxide film due to temperature cycles associated with the engine being turned on/off, thereby accelerating the oxidation of the base material.

In particular, with a recent increasing trend of “idling stop” (stopping the engine when a vehicle is not moving) as one of environmental conservation measures, the ON/OFF frequency of the engine is increasing. This results in an increased number of temperature cycles and an increased likelihood of cracking and separation of the oxide film.

In such still higher temperature environments, crystal grains constituting electrodes easily grow and become coarse. A decrease in the total length of grain boundaries due to coarsening makes it easier for oxygen to move from the outside of an electrode into the electrode through the grain boundaries, thus resulting in a high degree of penetration (an increased depth) and an increased likelihood of oxidation within the electrode (within the base material). Thus, use in still higher temperature environments requires improvement in oxidation resistance through the retardation of grain growth.

Furthermore, during the operation of a spark plug, nickel in the main phase of the electrode reacts with an element (such as an alkali metal element, an alkaline-earth metal element, or phosphorus) in the atmosphere derived from gasoline or an engine oil to form a granular compound containing nickel (hereinafter referred to as compound particles) on the electrode surface, particularly around the portion of spark discharge in the electrode (surfaces of the center electrode and the ground electrode facing each other), and the melting point of the portion to which the compound particles adhere partly decreases. This results in the melting of the main phase and further growth of the compound particles. Continuous formation and growth of the compound particles may destabilize the ignition of the engine, and in the worst case the compound particles may fall off and cause damage to the engine. Use of a spark plug in still higher temperature environments accelerates the formation and growth of the compound particles. Thus, it is also desirable to retard the formation and growth of the compound particles.

Furthermore, the present inventors found that the idling stop results in decreased temperatures of engine parts of the stopped engine and causes the formation of condensed water around the engine parts and the engine parts are immersed with condensed water. The present inventors also found that the condensed water may be mixed with elements around the engine parts (for example, NOx components resulting from EGR, phosphorus (P), which is probably an impurity of an engine oil, sulfur (S), which is probably an impurity of gasoline, and chlorides derived from the constituent materials of the engine parts) to form a corrosive liquid containing acids. An increase in the ON/OFF frequency due to the idling stop results in repeated formation of condensed water and a corrosive liquid derived from the condensed water. An increase in the stop time of the engine due to the idling stop results in successive immersion of the engine parts in the corrosive liquid. Thus, it is desirable that the spark-plug electrode material be resistant not only to simple oxidation at high temperatures but also to corrosion by aqueous solutions.

Accordingly, it is an object of the present invention to provide an electrode material that can constitute electrodes having high resistance to high-temperature oxidation and corrosion. It is another object of the present invention to provide a spark-plug electrode having high resistance to high-temperature oxidation and corrosion made of the electrode material and a spark plug including the spark-plug electrode.

### Solution to Problem

The present inventors studied preferred components to be added to Ni as constituent materials of spark-plug electrodes suitable for use in high-temperature environments and idling stop or EGR environments and obtained the following findings.

(1) Al, Si, Cr, and Y have an oxidation inhibiting effect at high temperatures.

(2) Si has a higher oxidation inhibiting effect than Al.

(3) Ti has an oxidation (particularly internal oxidation) inhibiting effect. The inclusion of Ti can reduce the Al and Si contents and prevent nitriding of Al.

(4) Y effectively retards the growth of crystal grains at high temperatures and allows fine crystal grains to be easily retained.

(5) Al, Si, and Cr reduce the formation of compound particles and have a sweating inhibiting effect at high temperatures.

(6) The inclusion of Al, Si, and Cr and a specific Si/Cr ratio result in improved corrosion resistance.

(7) The addition of Mn can inhibit internal oxidation, reduce sweating at high temperatures, and improve corrosion resistance.

(8) These additive element contents can be altered to suppress an increase in specific resistance and reduce spark erosion.

On the basis of these findings, Al, Si, Cr, Y, and Ti were selected as additive elements to be added to Ni in a spark-plug electrode material, and the Al, Si, Cr, Y, and Ti contents and the Si/Cr ratio were specified.

An electrode material according to one aspect of the present invention contains, on a mass percent basis, 0.005% or more and 0.2% or less Al, 0.2% or more and 1.6% or less Si, 0.05% or more and 1.0% or less Cr, 0.05% or more and 0.5% or less Ti, and 0.2% or more and 1.0% or less Y, the remainder being Ni and inevitable impurities. The electrode material has a Si/Cr mass ratio of 1 or more.

In an electrode material according to one aspect of the present invention containing a nickel alloy having the specific composition, (I) the inclusion of the specific amounts of Al, Si, Cr, and Y produces a satisfactory oxidation inhibiting effect, (2) the Si content higher than the Al content results in a further improved oxidation inhibiting effect, (3) the inclusion of the specific amount of Ti can prevent nitriding of Al and reduce the occurrence of expansion, cracking, and separation of an oxide film, and (4) the inclusion of the specific amount of Y can retard the growth of crystal grains at high temperatures. Because of these points, the electrode material has high oxidation resistance even in high-temperature environments.

In an electrode material according to one aspect of the present invention, (I) the additive elements to be added to Ni are specific amounts of specific elements; in particular, a low Al content and a relatively low Al and Si content result in a low specific resistance and high resistance to spark erosion, and (II) the inclusion of the specific amounts of Al, Si, and Cr in Ni can effectively retard the formation and growth of the compound particles during operation. Because of these points, the electrode material is resistant to sweating and spark erosion.

In an electrode material according to one aspect of the present invention, the inclusion of Al, Si, Cr, and optionally Mn improves the corrosion resistance of the nickel alloy, and the Si/Cr ratio of 1 or more results in high corrosion resistance of the oxide film.

Depending on the composition or operating conditions, the formation of an oxide film on an alloy surface of a spark-plug electrode exposed to a high temperature during the operation of the spark plug tends to improve corrosion resistance as compared with corrosion resistance in the absence of the oxide film. Thus, the oxide film is preferably formed on the spark-plug electrode during the operation of the spark plug. However, even having a large thickness, the oxide film that is porous or has a crack, for example, due to thermal cycles tends to undergo accelerated corrosion due to crevice corrosion. It is therefore desirable that the oxide film be of high density and strength and have a moderate thickness. As described below, an oxide film formed on a nickel alloy of an electrode material according to the present invention tends to have a two-layer structure that includes an inner oxide layer adjacent to the nickel alloy base material and a surface oxide layer formed on the front side of the oxide film. The inner oxide layer having a higher Ni content is more liable to suffer from corrosion than the base material. An excessively thick inner oxide layer preferentially suffers from corrosion and has low corrosion resistance. Thus, it may be preferable that the inner oxide layer has a relatively small thickness. An electrode material according to the present invention that has a Si/Cr ratio of 1 or more can easily form a dense and strong oxide film and inhibit internal oxidation. Thus, the inner oxide layer can have a relatively small thickness, and the oxide film has high adhesiveness. Because of high corrosion resistance of the oxide film formed during operation as well as high corrosion resistance of the nickel alloy base material, an electrode material according to the present invention for use in spark-plug electrodes is resistant to corrosion by corrosive aqueous solutions produced by idling stop or EGR.

An electrode material according to another aspect of the present invention further contains Mn in the nickel alloy. More specifically, the electrode material contains, on a mass percent basis, 0.005% or more and 0.2% or less Al, 0.2% or more and 1.6% or less Si, 0.05% or more and 1.0% or less Cr, 0.05% or more and 0.5% or less Ti, 0.2% or more and 1.0% or less Y, and 0.05% or more and 0.5% or less Mn, the remainder being Ni and inevitable impurities, and has a Si/Cr mass ratio of 1 or more.

Like Cr, Mn added to Ni is effective in retarding the formation of the compound particles and suppressing internal oxidation, thereby preventing excessive formation of the inner oxide layer. Thus, the electrode material further containing Mn is resistant to sweating, high-temperature oxidation, and corrosion. The electrode material having the specific Mn content rarely has an increased specific resistance and is resistant to spark erosion.

An electrode material according to one aspect of the present invention has a Y content of more than 0.3% on a mass percent basis.

The electrode material containing such a sufficient amount of Y is more resistant to high-temperature oxidation.

An electrode material according to one aspect of the present invention has a B content of more than 0% and 0.05% or less on a mass percent basis.

The electrode material containing B has improved hot workability and productivity.

An electrode material according to one aspect of the present invention has a specific resistance of 25 μΩ·cm or less at room temperature.

The electrode material having such a low specific resistance is resistant to spark erosion.

An electrode material according to one aspect of the present invention has an average grain size of 300 μm or less after heated at 1000° C. for 100 hours.

Since the electrode material has such a specific composition, the crystal grains of the electrode material and a spark-plug electrode made of the electrode material negligibly grow (rarely become coarse) and can maintain a small average grain size at very high temperatures, such as 1000° C. Thus, the electrode material can maintain a long total length of grain boundaries for a long time and is resistant to oxidation at high temperatures.

An electrode material according to one aspect of the present invention has an oxide film on the surface thereof when heated at 900° C. for 24 hours, and the oxide film has a two-layer structure including an inner oxide layer and a surface oxide layer and satisfies at least one of the following (A) to (D):

(A) the ratio of the thickness of the surface oxide layer to the thickness of the inner oxide layer (hereinafter referred to as a thickness ratio) is more than 16% and less than 173%,

(B) the surface oxide layer has a thickness of more than 15 μm and less than 57 μm,

(C) the inner oxide layer has a thickness of more than 33 μm and less than 80 μm, and

(D) the surface oxide layer and the inner oxide layer have a total thickness of more than 48 μm and less than 90 μm.

The electrode material exposed to a high temperature forms an oxide film having a specific thickness and thickness ratio due to which the electrode material is resistant to corrosion by corrosive aqueous solutions as described below in test examples. When the electrode material is used for a spark-plug electrode, because of the formation of the specific oxide film over time, the electrode can be resistant to corrosion.

An electrode material according to one aspect of the present invention has an oxide film on at least part of the surface thereof. The oxide film has a two-layer structure including an inner oxide layer and a surface oxide layer and satisfies at least one of (A) to (D) described above.

Originally having the oxide film resistant to corrosion, this electrode material is resistant to corrosion by corrosive aqueous solutions as described below in test examples. Thus, a spark-plug electrode made of the electrode material is originally resistant to corrosion before the formation of an oxide film during operation. Thus, the electrode material is expected to be resistant to corrosion for a long time from the beginning. Use of the electrode material for spark-plug electrodes is expected to obviate the necessity of plating for improving initial corrosion resistance.

The electrode material described above according to the present invention can be suitably used for spark-plug electrodes in internal combustion engines particularly used at very high temperatures, such as approximately 1000° C. or more. A spark-plug electrode according to the present invention is made of an electrode material according to the present invention.

A spark-plug electrode according to the present invention can constitute a spark plug that is resistant to high-temperature oxidation, spark erosion, sweating, and corrosion.

A spark-plug electrode according to one aspect of the present invention is made of an electrode material according to the present invention and has no oxide film on the surface thereof. A spark-plug electrode according to one aspect of the present invention is made of an electrode material according to the present invention and has an oxide film on at least part of the surface thereof. The oxide film has a two-layer structure including an inner oxide layer and a surface oxide layer and satisfies at least one of (A) to (D) described above.

A spark-plug electrode according to the present invention that originally has an oxide film resistant to corrosion is resistant to corrosion by corrosive aqueous solutions as described below in test examples. Thus, the spark-plug electrode that originally has the oxide film is expected to be resistant to corrosion for a long time from the beginning without the formation of an oxide film during operation. Furthermore, the spark-plug electrode that originally has the oxide film does not require plating for improving initial corrosion resistance and is expected to have improved productivity.

A spark plug according to one aspect of the present invention includes a spark-plug electrode according to the present invention.

A spark plug according to the present invention includes a spark-plug electrode according to the present invention resistant to high-temperature oxidation, spark erosion, sweating, and corrosion and is expected to properly operate for a long time even in the case of frequent idling stop or EGR. A spark plug including a spark-plug electrode having a specific oxide film is expected to be resistant to corrosion for a long time from the beginning.

### Advantageous Effects of Invention

A spark-plug electrode according to the present invention and a spark plug according to the present invention including the spark-plug electrode are resistant to high-temperature oxidation and corrosion. An electrode material according to the present invention can be used to manufacture a spark-plug electrode that is resistant to high-temperature oxidation and corrosion.

### BRIEF DESCRIPTION OF DRAWINGS

FIG. 1 is an optical micrograph showing the oxidation state of an electrode material.

### DESCRIPTION OF EMBODIMENTS

The present invention will be further described below. Unless otherwise specified, the element content is based on the mass percentage.

### [Electrode Material]

### <Composition>

An electrode material according to an embodiment of the present invention is made of a nickel alloy that contains Al, Si, Cr, Y, Ti, and optionally Mn as additive elements and Ni and inevitable impurities as the remainder. Since the electrode material contains Ni as the main component (95% by mass or more, preferably 97% by mass or more), the electrode material has high plastic formability and a low specific resistance (high electrical conductivity), and a spark-plug electrode made of the electrode material can be resistant to spark erosion. Lower additive element contents and a higher Ni content (for example, Ni: 98% by mass or more) can result in a lower specific resistance. Higher additive element contents can result in higher resistance to high-temperature oxidation or corrosion.

### (Al: Aluminum, Si: Silicon)

Al and Si are elements having an oxidation inhibiting effect. The inclusion of Al and Si in Ni allows an oxide containing Al and Si to be intentionally formed or formed over time (an oxide film can be intentionally formed or formed over time) on the surface of the electrode material and thereby prevent the penetration of oxygen into the electrode material (base material) and prevent oxidation, particularly internal oxidation. Suppression of internal oxidation prevents the inner oxide layer from excessively growing, thus resulting in the formation of a dense and adhesive oxide film and allowing the oxide film to be maintained. The inclusion of Al and Si together with Cr and Mn described below in Ni reduces the formation of compound particles and improve resistance to sweating. A higher Al or Si content results in increased formation of an oxide on the surface of the electrode material and consequently the suppression of internal oxidation and the retardation of the formation and growth of compound particles. An excessively high Al or Si content, however, results in the formation of a porous oxide film on the surface of the electrode material, expansion and cracking or rupture of the oxide film, or separation of the oxide film. Cracking or separation of the oxide film may result in the progression of oxidation over time and the progression of corrosion by a corrosive liquid in some operating environments. Furthermore, a higher Al or Si content tends to result in a higher specific resistance and lower resistance to spark erosion. Thus, an electrode material according to an embodiment of the present invention contains relatively small amounts of Al and Si in Ni and contains Ti as an element having an internal oxidation inhibiting effect. The present inventors found that Si has a higher oxidation inhibiting effect than Al. Thus, an electrode material according to an embodiment of the present invention contains a higher amount of Si than Al in Ni. The specific contents are as follows: Al: 0.005% or more and 0.2% or less and Si: 0.2% or more and 1.6% or less, more preferably Al: 0.01% or more and 0.15% or less and Si: 0.5% or more and 1.5% or less, still more preferably 1.3% or less.

### (Y: Yttrium)

Y mainly forms an intermetallic compound with Ni of the alloy main phase and exists as the intermetallic compound. A small portion of Y is dissolved in Ni to form a solid solution. Because of the pinning effect of the intermetallic compound, an electrode material according to an embodiment of the present invention can effectively retard the growth of crystal grains at very high temperatures, such as 900° C. or more or even 1000° C. or more. Thus, a spark-plug electrode according to an embodiment of the present invention made of an electrode material according to an embodiment of the present invention can maintain fine crystal grains for a long time even at very high temperatures as described above, can prevent the penetration of oxygen, and can effectively inhibit internal oxidation. In order to achieve such high oxidation resistance, particularly resistance to high-temperature oxidation, the Y content is preferably 0.2% or more. A higher Y content tends to result in finer crystal grains and higher resistance to high-temperature oxidation. An Y content of 1.0% or less results in the suppression of thermal degradation of the electrode due to an increased specific resistance and high resistance to spark erosion. An Y content of 1.0% or less also results in the suppression of degradation of plastic formability, thereby improving the formability of the electrode having a predetermined shape and the manufacturability of the electrode. Since Y absorbs less hydrogen than the other rare-earth elements, an electrode material according to an embodiment of the present invention rarely undergoes hydrogen embrittlement even when subjected to heat treatment in an atmosphere containing hydrogen in the manufacturing process. The Y content is more preferably more than 0.3% and 0.75% or less.

### (Cr: Chromium, Mn: Manganese)

As described above, the inclusion of Cr and optionally Mn together with Al and Si reduces the formation of the compound particles. This is probably because Cr and Mn together with Al and Si react with an element in the atmosphere, for example, P in gasoline or engine oil, and thereby prevent Ni in the alloy main phase from reacting with P and reduce the deposition of a Ni—P compound on the electrode. Cr and Mn are also effective in preventing internal oxidation. Cr is resistant to corrosive liquids produced by the operation of a spark plug, tends to more effectively reduce the formation of the compound particles than Mn, and is less likely to increase specific resistance than Al. Thus, an electrode material according to an embodiment of the present invention contains a relatively small amount of Al in Ni as described above, contains Cr as an essential element, and optionally contains Mn. A higher Cr content results in higher resistance to the formation and growth of the compound particles and higher resistance to internal oxidation and corrosion. An excessively high Cr content, however, results in an excessively high specific resistance. A higher Mn content results in higher resistance to the formation and growth of the compound particles and higher resistance to internal oxidation. An excessively high Mn content, however, results in an increased specific resistance or low corrosion resistance. Thus, the Cr content is 0.05% or more and 1.0% or less. When the electrode material contains Mn, the Mn content is preferably 0.05% or more and 0.5% or less. More preferred contents are as follows: Cr: 0.1% or more, still more preferably 0.2% or more and 0.8% or less, Mn: 0.05% or more and 0.3% or less.

### (Ti: Titanium)

As described above, Ti can effectively prevent internal oxidation. This effect becomes more significant with increasing Ti content. An excessively high Ti content, however, results in an increased specific resistance. As described above, Ti can prevent the formation of Al nitride (AlN) and effectively prevent oxidation due to cracking in an oxide film caused by thermal expansion associated with the formation of Al nitride. In order to sufficiently produce these effects, the Ti content is 0.05% or more and 0.5% or less, preferably 0.1% or more and 0.3% or less.

### (Si/Cr≧1)

An electrode material according to an embodiment of the present invention having the Si and Cr contents described above has a Si/Cr ratio of 1 or more, that is, the Si content is greater than or equal to the Cr content. Satisfying this condition can enhance the oxidation inhibiting effect, particularly the internal oxidation inhibiting effect, of Si and Cr, thus resulting in the formation of a dense and adhesive oxide film having a relatively thin inner oxide layer. This oxide film can improve the resistance to high-temperature oxidation and resistance to corrosion by corrosive liquids produced from the ambient environment during use of an electrode material or an electrode. The corrosion resistance tends to increase with increasing Si/Cr ratio. The Si/Cr ratio is preferably more than 1, more preferably 1.3 or more and 35 or less, still more preferably 1.3 or more and 6 or less.

(B: boron)

The inclusion of more than 0% and 0.05% or less, preferably 0.001% or more and 0.02% or less, B can improve hot workability, thereby improving the productivity of an electrode material or a spark-plug electrode according to an embodiment of the present invention.

The additive element contents described above can be controlled in the specific ranges by altering the amounts of elements added to the raw materials of the electrode material. In addition to these additive elements, a minute amount of C may be added to increase high temperature strength if desired. An excessively high C content tends to result in poor processability. Thus, the C content is preferably 0.05% by mass or less.

### <Oxidation Resistance>

An electrode material according to an embodiment of the present invention exposed to a high-temperature environment, such as 900° C. or more or even 1000° C. or more, for a long time is resistant to high-temperature oxidation and can retain fine crystal grains. For example, an electrode material according to an embodiment of the present invention can have an average grain size of 300 μm or less after heating at 1000° C. for 100 hours. The condition of “1000° C. for 100 hours” is comparable to or severer than the maximum attained temperature of gasoline engines of known typical automobiles and is a very severe condition because of the long heating time. Even after heating under such a severe condition, smaller crystal grains of an electrode material allow less oxygen to penetrate into the alloy base material and are considered to be resistant to high-temperature oxidation. Thus, the present invention employs “the average grain size after heating at 1000° C. for 100 hours” as an indicator for resistance to high-temperature oxidation. The average grain size can vary with the additive element contents. For example, an electrode material according to an embodiment of the present invention has an average grain size of 200 μm or less, 150 μm or less, 120 μm or less, or 100 μm or less. As described above, a smaller average grain size results in a longer total length of grain boundaries and makes it easier to prevent the penetration of oxygen in the alloy base material. Thus, there is no particular lower limit to the average grain size. In particular, “the average grain size after heating at 1000° C. for 100 hours” tends to decrease with increasing Y content.

### <Specific Resistance>

An electrode material according to an embodiment of the present invention has a low specific resistance, for example, 25 μΩ·cm or less, at room temperature (typically approximately 20° C.). The specific resistance varies principally with the additive element contents. A lower additive element content tends to result in a lower specific resistance, for example, 20 μΩ·cm or less or even 15 μΩ·cm or less. A lower specific resistance tends to result in higher resistance to spark erosion. Thus, there is no particularly lower limit to the specific resistance. Although pure nickel or Ni-rich alloys having a high Ni content (typically the total additive elements content: 1% by mass or less) have a low specific resistance, pure nickel or Ni-rich alloys have low resistance to high-temperature oxidation or corrosion and have an average grain size of more than 300 μm, for example.

### <Corrosion Resistance>

As described below, the present inventors found that an oxide film having a specific state after high-temperature oxidation is resistant to corrosion. More specifically, the present inventors found that oxidation of an electrode material by heating at 900° C. for 24 hours forms an oxide film having the two-layer structure including an inner oxide layer and a surface oxide layer on the surface of the electrode material, and the oxide film that satisfies at least one of the following (A) to (D) is resistant to corrosion. The present inventors also found that the oxide film formed by heating at 900° C. for 24 hours is closer to the oxide film of a spark plug used in an actual automobile than the oxide film formed by heating under the condition of 1000° C. for 100 hours for the evaluation of resistance to high-temperature oxidation. In other words, the oxidation condition of 900° C. for 24 hours more accurately simulates the actual operating environment. Thus, the present invention employs “the state of an oxide film after heating at 900° C. for 24 hours” as an indicator for corrosion resistance.

(A) The thickness ratio: more than 16% and less than 173%, (B) the thickness of the surface oxide layer: more than 15 μm and less than 57 μm, (C) the thickness of the inner oxide layer: more than 33 μm and less than 80 μm, and (D) the total thickness of the surface oxide layer and the inner oxide layer: more than 48 μm and less than 90 μm.

The oxide film that satisfies at least one of (A) to (D) is expected to have an appropriate thickness during operation. The oxide film has high density and adhesiveness, as described above. Thus, the oxide film is resistant to corrosion. The oxide film may satisfy at least one, at least two, at least three, or all of (A) to (D). The thickness measurement method will be described below.

The present inventors further found that an electrode that has an oxide film satisfying at least one of (A) to (D) manufactured using an electrode material that has the specific composition described above and has an oxide film satisfying at least one of (A) to (D) or an electrode that has an oxide film subjected to oxidation treatment of an electrode base material having the specific composition described above and satisfying at least one of (A) to (D) has high initial corrosion resistance and high corrosion resistance for a long time from the beginning. Even having substantially no specific oxide film satisfying at least one of (A) to (D) before the operation of the spark plug, the electrode material or electrode having the specific composition has the specific oxide film over time as described above, depending on the composition or operating conditions, and becomes resistant to corrosion. In order to develop corrosion resistance before the formation of the specific oxide film, however, it is desirable to have a plating layer, for example. This requires plating and reduces productivity. The formation of the specific oxide film before operation can obviate the necessity of plating and develop corrosion resistance from the beginning. The oxide film that is resistant to corrosion from the beginning retards oxidation over time and is expected to facilitate the prevention of oxidation (particularly internal oxidation). Thus, an electrode material according to an embodiment of the present invention has an oxide film that satisfies at least one of (A) to (D) on at least part of the surface thereof. The electrode material having the specific oxide film can be used to manufacture an electrode that has the specific oxide film on at least part of the surface thereof.

### <Shape>

An electrode material according to an embodiment of the present invention is typically a wire manufactured by wire drawing. The wire may have any cross-sectional shape, such as rectangular or circular. The wire may have any appropriate cross section size and diameter. For example, a rectangular wire having a rectangular cross section has a thickness in the range of approximately 1 to 3 mm and a width in the range of approximately 2 to 4 mm, and a round wire having a circular cross section has a diameter in the range of approximately 2 to 6 mm.

### [Manufacturing Method]

An electrode material according to an embodiment of the present invention is typically manufactured by a process including melting→casting→hot rolling→cold wire drawing and heat treatment (→optionally oxidation). When the oxygen concentration of the atmosphere of melting or casting is lower than the oxygen concentration in the air (for example, oxygen concentration: 10% by volume or less), this reduces the oxidation of Y and allows an intermetallic compound containing Y to be sufficiently present in the electrode material.

If necessary, final heat treatment (annealing) after cold wire drawing may preferably be performed in a nonoxidizing atmosphere (for example, a low-oxygen-concentration atmosphere or an atmosphere substantially free of oxygen, such as a hydrogen atmosphere or a nitrogen atmosphere) at a heating temperature in the range of approximately 700° C. to 1000° C., particularly 800° C. to 950° C. Such annealing can facilitate processing of an electrode material into a predetermined electrode shape or relieve processing strain due to the preceding processing and thereby reduce the specific resistance of the electrode material or formed electrode. The cold wire drawing may be followed by rolling. The rolling can alter the shape of the wire (for example, from a circular cross section to a rectangular cross section). The rolling may be followed by the annealing.

The manufacture of an electrode material having the specific oxide film involves heat treatment (oxidation treatment) for forming the oxide film after the cold wire drawing, rolling, or annealing. The conditions for the oxidation treatment are controlled such that the oxide film has a desired thickness ratio or thickness. For example, for batch treatment, the heating temperature may be 800° C. or more and 1100° C. or less, preferably 900° C. or more and 1000° C. or less. The atmosphere contains oxygen. The air atmosphere is easy to control and can reduce the time to form the oxide film and improve productivity because of the relatively high oxygen concentration. The atmosphere may be an oxygen-deficient atmosphere having an oxygen concentration of 0.02% by volume or more and 20% by volume or less or an oxygen-rich atmosphere having an oxygen concentration of more than 20% by volume. The ambient gases other than oxygen include an inert gas, such as nitrogen, argon, or helium. The retention time depends on the oxygen concentration. For example, the retention time in the air atmosphere may be 1 hour or more and 100 hours or less, 1 hour or more and 72 hours or less, particularly 2 hours or more and 24 hours or less. The retention time in an oxygen-deficient atmosphere may be 2 hours or more and 200 hours or less, 3 hours or more, particularly 10 hours or more and 100 hours or less. The retention time in an oxygen-rich atmosphere may be 0.5 hours or more and 50 hours or less.

The oxidation treatment may be batch treatment or continuous treatment. The continuous treatment may be performed with an electric furnace utilizing induction heating or resistance heating or an atmosphere furnace. The conditions for continuous treatment are also controlled such that the oxide film has the specific thickness ratio or thickness. For example, in the case of an electric furnace, the linear velocity, the size of the objective to be heated (wire diameter), and the electric current are controlled. In the case of an atmosphere furnace, the linear velocity, the size of the objective to be heated (wire diameter), and the size of the furnace (the diameter of a pipe furnace, for example) are controlled.

The region of the oxide film on the electrode material may be appropriately determined. Typically, a wire may have the oxide film over the entire outer surface. This can obviate the necessity of masking and easily form a wire having the oxide film.

### [Spark-Plug Electrode]

An electrode material according to an embodiment of the present invention can be suitably used as a constituent material for a center electrode and a ground electrode of a spark plug. The ground electrode is often closer to a combustion chamber than the center electrode in internal combustion engines, such as automotive engines. Because of its satisfactory high-temperature characteristics as described above, an electrode material according to an embodiment of the present invention can be suitably used as a constituent material even for the ground electrode. A spark-plug electrode according to an embodiment of the present invention can be manufactured by cutting the electrode material into pieces having an appropriate length and forming the cut piece into a predetermined shape.

An electrode having the specific oxide film may be an electrode having the oxide film over substantially the entire outer surface thereof or an electrode having the oxide film only on part of the outer surface thereof (for example, a portion of the ground electrode not facing the center electrode or a portion of the center electrode not facing the ground electrode). Such an electrode having the oxide film may be manufactured using an electrode material having the oxide film or forming an electrode material having no oxide film into a desired electrode shape and subjecting the electrode material to the oxidation treatment described above. After cutting, an electrode material having an oxide film has no oxide film on the section thereof. An electrode manufactured using a material partly having no oxide film does not necessarily have the oxide film over the entire outer surface, provided that the electrode has the oxide film on a desired portion thereof. The oxidation treatment of an electrode base material having a desired electrode shape as described above can easily produce an electrode having the oxide film over the entire outer surface thereof or only in a desired region of the outer surface thereof.

### [Spark Plug]

A spark-plug electrode according to an embodiment of the present invention (having or not having the specific oxide film) can be suitably used as a constituent of a spark plug for use in the ignition of internal combustion engines, such as automotive engines. A spark plug according to an embodiment of the present invention typically includes an insulator, a metal shell for holding the insulator, a center electrode held in the insulator and partly protruding from the tip of the insulator, a ground electrode welded to the tip of the metal shell at one end thereof and facing an end face of the center electrode at the other end thereof, and a terminal metal fitting disposed at the rear end of the insulator. A known spark-plug electrode may be replaced by a spark-plug electrode according to an embodiment of the present invention.

### Test Example

A plurality of nickel alloy wires (electrode materials) were manufactured as materials for spark-plug electrodes for use in the ignition of general automotive gasoline engines, and the characteristics of the nickel alloy wires were examined.

The wires were manufactured as described below. Molten nickel alloys having the compositions listed in Table I (expressed in % by mass, Si/Cr refers to the mass ratio) were manufactured with a general vacuum melting furnace. The raw materials of the molten alloys were commercially available pure Ni (99.0% by mass or more Ni) and particles of additive elements. The molten alloys were refined to reduce or remove impurities and inclusions. The samples were refined so as to remove substantially all C (C: 0.05% by mass or less). Melting was performed while the atmosphere was controlled to have a low oxygen concentration. Vacuum casting was performed while the molten metal temperature was appropriately controlled, thereby yielding an ingot (2 tons).

TABLE 1

| | Components (mass %) | | | | | | | | |
|---|---|---|---|---|---|---|---|---|---|
| Sam- | | | | | | | | | Re- |
| ple | | | | | | | | Si/ | main- |
| No. | B | Al | Si | Cr | Mn | Ti | Y | Cr | der |
| 1 | — | 0.020 | 0.25 | 0.20 | — | 0.10 | 0.35 | 1.25 | Ni |
| 2 | — | 0.100 | 0.50 | 0.20 | — | 0.10 | 0.35 | 2.5 | Ni |
| 3 | — | 0.008 | 0.90 | 0.15 | — | 0.10 | 0.35 | 6 | Ni |
| 4 | — | 0.050 | 1.30 | 0.50 | — | 0.30 | 0.35 | 2.6 | Ni |
| 5 | — | 0.050 | 0.50 | 0.20 | 0.1 | 0.10 | 0.35 | 2.5 | Ni |
| 6 | — | 0.100 | 0.80 | 0.20 | 0.1 | 0.10 | 0.35 | 4 | Ni |
| 7 | 0.01 | 0.100 | 1.30 | 0.80 | 0.1 | 0.15 | 0.45 | 1.63 | Ni |
| 8 | — | 0.010 | 0.80 | 0.60 | 0.08 | 0.05 | 0.25 | 1.33 | Ni |
| 9 | 0.01 | 0.010 | 0.80 | 0.50 | 0.05 | 0.10 | 0.75 | 1.6 | Ni |
| 10 | — | 0.020 | 0.20 | 0.20 | — | 0.10 | 0.35 | 1 | Ni |
| 11 | — | 0.100 | 1.60 | 0.05 | 0.2 | 0.10 | 0.35 | 32 | Ni |
| 101 | — | — | 0.25 | — | — | — | 0.35 | — | Ni |
| 102 | — | 0.500 | 1.00 | 1.50 | 0.50 | 0.10 | 0.40 | 0.67 | Ni |
| 103 | — | 1.500 | 1.50 | 1.50 | 0.20 | 0.10 | 0.30 | 1 | Ni |
| 104 | — | 0.300 | 1.70 | 1.20 | 0.8 | 0.6 | 0.50 | 1.42 | Ni |
| 105 | — | 0.020 | 0.30 | 0.80 | 0.10 | 0.10 | 0.40 | 0.38 | Ni |
| 106 | — | 0.05 | 2 | 0.05 | 0.1 | 0.1 | 0.35 | 40 | Ni |

The ingot was reheated and forged to form a billet approximately 150 mm square. The billet was hot-rolled to produce a rolled wire having a diameter of 5.5 mm. The rolled wire was subjected to cold wire drawing and heat treatment to produce a cold-drawn wire (round wire) having a diameter of 2.5 mm and a cold-drawn wire (round wire) having a diameter of 4.2 mm. The cold-drawn wire (round wire) having a diameter of 2.5 mm was further rolled to produce a rectangular wire having a 1.5 mm×2.8 mm rectangular cross section. The rectangular wire and the round wire having a diameter of 4.2 mm were subjected to final heat treatment (annealing, temperature: 800° C. to 1000° C., in a nonoxidizing atmosphere (nitrogen atmosphere or hydrogen atmosphere), in a continuous annealing furnace) to produce annealed materials. These annealed materials were used as sample electrode materials. The annealed materials were cut into pieces having an appropriate length and were then formed into a predetermined shape to produce a spark plug ground electrode (using the 1.5 mm×2.8 mm rectangular wire) and a spark plug center electrode (using the round wire having a diameter of 4.2 mm) for use in general passenger cars. These electrodes were used as sample electrodes.

### <Composition>

The compositions of the sample electrode materials (annealed materials) measured with an inductively coupled plasma (ICP) spectrometer were similar to the compositions listed in Table I and were composed of the additive elements listed in Table I and the remainder Ni and inevitable impurities. The samples had a Ni content of 90% by mass or more (the samples No. 1 to No. 11 had a Ni content of 97% by mass or more). In addition to ICP spectroscopy, the compositions may be measured by atomic absorption spectrometry. “- (hyphen)” in Table I means that the measurement was below the detection limit and the composition contained substantially no corresponding element. The samples containing Y were observed with a scanning electron microscope (SEM) and subjected to elementary analysis by energy dispersive X-ray (EDX) analysis or analyzed with an electron probe microanalyzer (EPMA). The analysis showed the presence of an intermetallic compound of Y and Ni.

### <Specific Resistance>

The specific resistance of the sample electrode materials (annealed materials) was measured. Table II shows the results. The specific resistance (at room temperature) was measured with an electrical resistance measuring apparatus using a direct-current four-terminal method (gauge length GL=100 mm).

### <Oxidation Resistance>

The resistance to high-temperature oxidation of the samples was examined. A ground electrode formed of the 1.5 mm×2.8 mm rectangular wire (annealed material) and a center electrode formed of the round wire (annealed material) having a diameter of 4.2 mm were heated in an air atmosphere furnace at 1000° C. for one hour, were then cooled in the air in the outside of the air atmosphere furnace for 30 minutes, and were then reheated for one hour. This temperature cycle was repeatedly performed until the total heating time reached 100 hours. The thickness and state of an oxide film were observed in this high-temperature oxidation test.

After the high-temperature oxidation test, the cross section of the ground electrode was observed with an optical microscope (at a magnification in the range of 50 to 200). The microscope image (micrograph) was used to measure the thickness of an oxide film formed on the surface of the ground electrode.

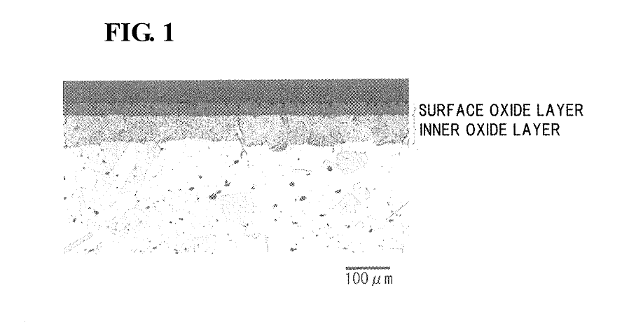

Table II shows the results. The electrodes made of the nickel alloys in this test had an oxide film having a two-layer structure as shown in FIG. 1. More specifically, the oxide film of the electrodes included a surface oxide layer on the outermost surface thereof and its vicinity and a Ni-rich inner oxide layer disposed inside of the surface oxide layer. The surface oxide layer had high additive element contents and a low Ni content. The electrode shown in FIG. 1 is an explanatory sample made of a known nickel alloy and subjected to the high-temperature oxidation test at 900° C. for 100 hours. In this test, the thicknesses of the inner oxide layer and the surface oxide layer were measured. The thickness of the inner oxide layer was an average thickness from the boundary between the base material region formed of the nickel alloy and the inner oxide layer to the boundary between the inner oxide layer and the surface oxide layer. The thickness of the surface oxide layer was an average thickness from the boundary between the both oxide layers to the outermost surface of the oxide film. The average thickness can be easily determined through image processing of the microscope image. A lower degree of penetration of oxygen in the electrode base material results in a smaller thickness of the inner oxide layer and higher resistance to internal oxidation. The results for the center electrode were similar to the results for the ground electrode and were not described.

When the total thickness of the surface oxide layer and the inner oxide layer was less than 200 μm, the resistance to high-temperature oxidation was rated good. When the total thickness was less than 170 μm and the oxide film included little expansion or few cracks, the resistance to high-temperature oxidation was rated excellent. Table II also lists the evaluation results of resistance to high-temperature oxidation. Table II also lists expansion, cracking, or separation of the oxide film.

### <Average Grain Size>

The average grain size of the sample electrodes subjected to the high-temperature oxidation test was measured. Table II shows the results. The average grain size was measured by observing a cross section of the ground electrode with an optical microscope (at a magnification in the range of 50 to 200) and applying an intersection method (line method) to the microscope image (micrograph).

### <Resistance to Spark Erosion>

The erosion of the sample electrode materials (annealed materials) were examined using an impulse. An impulse that simulated an ignition spark in engines was applied to the samples with an impulse test apparatus. The impulse was a long wave having a frequency of 10/350 μs (in the impulse waveform, the time from the leading edge to the peak was 10 μs and the time from the leading edge to the half peak through the peak was 350 μs) and had an output of a few kilovolts. After the application of the impulse, the maximum depth (consumption) of a hollow formed in the samples was measured. When the sample satisfied the formula I: Cₛ>{(3×C₁₀₁+1×C_{Inc})/4}, wherein C₁₀₁ denotes the consumption of the sample No. 101, C_{Inc} denotes the consumption of a sample manufactured using a rectangular wire made of commercially available Inconel (registered trademark) 600, and Cₛ denotes the consumption of the sample measured, and had a specific resistance (at room temperature) of 25 μΩ·cm or less, the resistance to spark erosion was rated good. When the sample did not satisfy the formula I or had a specific resistance (at room temperature) of more than 25 μΩ·cm, the resistance to spark erosion was rated poor. Table II shows the evaluation results.

### <Resistance to Sweating>

The resistance to sweating of the sample electrode materials (annealed materials) was evaluated. An engine oil was applied to the 1.5 mm×2.8 mm rectangular wire (annealed material), and the rectangular wire was placed in a circular furnace that could operate in a controlled atmosphere. The furnace was heated to 1100° C. so that the combustion temperature was approximately 100° C. higher than the combustion temperature of general automotive gasoline engines (approximately in the range of 900° C. to 1000° C.). The sample was held for 60 hours in total in an atmosphere that simulated the inside of the engines while an exhaust gas from a test gasoline engine (displacement of 2000 cc, 6 cylinders) was supplied to the furnace. The sample was exposed to combustion flames generated by the combustion of the engine oil. Combustion products (compounds) were deposited on the surface of the sample. The surface of the heated sample was observed with SEM and EPMA to check for the presence of the products (compounds).

As a result of the observation, when the sample swelled with large compound particles or had compound particles over the entire surface thereof, the resistance to sweating was rated poor. When the sample had a few compound particles, the resistance to sweating was rated good. When the sample had few compound particles, the resistance to sweating was rated excellent. Table II shows the evaluation results.

### <Corrosion Resistance>

The corrosion resistance of the sample electrode materials (annealed materials) was evaluated. The present inventors examined the corrosion of a sample spark-plug electrode in gasoline automobiles (utility vehicles) and studied various reproducibility tests for the corrosion. The present inventors found that an oxide film formed at high temperatures and immersed in a corrosive liquid containing an aqueous acid (such as aqueous nitric acid, phosphoric acid, or sulfuric acid) can simulate the corrosion of the sample actually used in the automobiles. The addition of sodium chloride (NaCl) to the corrosive liquid containing the aqueous acid can accelerate the corrosion and shorten the corrosion test time. Thus, the corrosion resistance test method employed in the present example includes high-temperature oxidation and subsequent immersion in an aqueous solution of NaCl+acid. More specifically, the high-temperature oxidation conditions were 900° C. for 24 hours in the air atmosphere (in an air atmosphere furnace), and the corrosive liquid was an aqueous NaCl solution containing nitric acid and phosphoric acid. The corrosive liquid was prepared by mixing nitric acid, phosphoric acid, and an aqueous NaCl such that the mass ratio of nitric acid/phosphoric acid/5% by mass aqueous sodium chloride was 5/5/90. A sample was immersed in the corrosive liquid at 80° C. for a predetermined time. The retention time ranged from 3 to 15 hours. After immersion for the predetermined retention time, the sample was washed with water. The decrease in cross-sectional area was measured in a cross section polisher (CP) cross section. More specifically, the decrease in cross-sectional area (%)={(cross-sectional area before corrosion resistance test−cross-sectional area after corrosion resistance test)/cross-sectional area before corrosion resistance test)}×100 was calculated. When the decrease in cross-sectional area was less than 5%, the corrosion resistance was rated excellent. When the decrease in cross-sectional area was 5% or more and less than 10%, the corrosion resistance was rated good. When the decrease in cross-sectional area was 10% or more, the corrosion resistance was rated poor. Table II shows the evaluation results.

As a result of the examination of the samples that were resistant to corrosion in the corrosion resistance test, it was found that there is a relationship between the state of the oxide film after the high-temperature oxidation test and corrosion resistance. Thus, the state of the oxide film after high-temperature oxidation in the corrosion resistance test was examined. Table III shows the results. Measurements were performed with respect to the thickness of the surface oxide layer, the thickness of the inner oxide layer, and the total thickness of the oxide layers (all in μm), and the thickness ratio (%) of the thickness of the surface oxide layer to the thickness of the inner oxide layer. These thicknesses were measured in the same manner as in the high-temperature oxidation test.

TABLE II

| | | High-temperature oxidation resistance | | | | | Average | | | |
|---|---|---|---|---|---|---|---|---|---|---|
| | Specific | (1000° C. × 100 H) Rectangular wire | | | | | Grain | Spark | | |
| Sample | resistance | Thickness of oxide film (μm) | | | | | size | erosion | Sweating | Corrosion |
| No. | (μΩ · cm) | Surface | Inner | Total | Note | Rating | (μm) | resistance | resistance | resistance |
| 1 | 12.2 | 48 | 127 | 175 | — | good | 110 | good | good | excellent |
| 2 | 13.8 | 43 | 120 | 163 | — | good | 113 | good | good | excellent |
| 3 | 14.0 | 43 | 119 | 162 | — | good | 120 | good | good | excellent |
| 4 | 20.1 | 35 | 112 | 147 | — | good | 108 | good | good | excellent |
| 5 | 13.6 | 42 | 123 | 165 | — | good | 116 | good | good | excellent |
| 6 | 15.3 | 40 | 110 | 150 | — | good | 109 | good | good | excellent |
| 7 | 23.7 | 32 | 80 | 112 | — | good | 51 | good | good | excellent |
| 8 | 18.1 | 38 | 125 | 163 | — | good | 275 | good | good | excellent |
| 9 | 18.3 | 35 | 70 | 105 | — | excellent | 39 | good | good | excellent |
| 10 | 12.6 | 78 | 100 | 178 | — | excellent | 100 | good | good | excellent |
| 11 | 16.8 | 85 | 75 | 160 | Insignificant expansion | | 122 | good | good | excellent |
| | | | | | and cracking | | | | | |
| 101 | 9.5 | 54 | 140 | 194 | — | good | 128 | good | poor | poor |
| 102 | 29.0 | 29 | 15 | 44 | — | good | 59 | poor | good | poor |
| 103 | 39.0 | 25 | 13 | 38 | Insignificant expansion | | 264 | poor | good | good |
| | | | | | and cracking | | | | | |
| 104 | 33.3 | 23 | 12 | 35 | Insignificant expansion | | 42 | poor | good | poor |
| | | | | | and cracking | | | | | |
| 105 | 17.4 | 96 | 65 | 161 | — | excellent | 63 | good | excellent | poor |
| 106 | 17.2 | 20 | 130 | 150 | — | excellent | 120 | good | good | poor |

TABLE III

| | Corrosion resistance test | | | | |
|---|---|---|---|---|---|
| | High-temperature oxidation conditions | | | | |
| | (900° C. × 24 H) Rectangular wire | | | | |
| | Thickness | | | | |
| | of oxide film | | | | |
| | (μm) | | | Surface/inner × | Corrosion |
| Sample No. | Surface | Inner | Total | 100 (%) | resistance |
| 1 | 24 | 64 | 88 | 38 | excellent |
| 2 | 22 | 60 | 82 | 37 | excellent |
| 3 | 22 | 60 | 82 | 37 | excellent |
| 4 | 17 | 56 | 73 | 30 | excellent |
| 5 | 21 | 61 | 82 | 34 | excellent |
| 6 | 20 | 55 | 75 | 36 | excellent |
| 7 | 16 | 40 | 56 | 40 | excellent |
| 8 | 19 | 63 | 82 | 30 | excellent |
| 9 | 18 | 35 | 53 | 51 | excellent |
| 10 | 25 | 64 | 89 | 39 | excellent |
| 11 | 44 | 38 | 82 | 116 | excellent |
| 101 | 15 | 96 | 111 | 16 | poor |
| 102 | 15 | 8 | 23 | 188 | poor |
| 103 | 12 | 6 | 18 | 200 | good |
| 104 | 15 | 5 | 20 | 300 | poor |
| 105 | 57 | 33 | 90 | 173 | poor |
| 106 | 10 | 80 | 90 | 13 | poor |

Table II shows that the samples No. 1 to No. 11, which had specific Al, Si, Cr, Y, and Ti contents and had a specific composition having a Si/Cr ratio of 1 or more, had high oxidation resistance even at high temperatures, such as 1000° C. or more. More specifically, the samples No. 1 to No. 11 included a sufficient inner oxide layer not having an excessively large thickness (thickness after 1000° C. for 100 hours: 70 μm or more and less than 140 μm). The samples No. 1 to No. 10 were substantially free of expansion, cracking, and separation of the oxide film. This is probably partly because of the inclusion of relatively small amounts of Al and Si in Ni and appropriate amounts of Cr and Ti. The samples No. 1 to No. 11 had fine crystal grains of 300 μm or less even after exposed to such a high temperature for a long time. In this test, many samples had an average grain size of 150 μm or less, and some samples had an average grain size of 100 μm or less. This is probably partly because of the inclusion of a proper amount of Y.

The samples No. 1 to No. 11 having the specific compositions were not significantly corroded by the corrosive liquid and were resistant to the corrosive liquid. Table III shows that the oxide film of the samples No. 1 to No. 11 after high-temperature oxidation (900° C. for 24 hours) satisfied at least one of (A) the thickness ratio: more than 16% and less than 173%, (B) the thickness of the surface oxide layer: more than 15 μm and less than 57 μm, (C) the thickness of the inner oxide layer: more than 33 μm and less than 80 μm, and (D) the total thickness: more than 48 μm and less than 90 μm. This shows that an oxide film satisfying at least one of (A) to (D) after the high-temperature oxidation is resistant to corrosion. Electrodes made of such an electrode material are expected to have an oxide film on the surface thereof over time and be resistant to corrosion.

In the following example, the high temperature oxidation treatment in the corrosion resistance test was performed in advance to form an oxide film satisfying at least one of (A) the thickness ratio: more than 16% and less than 173%, (B) the thickness of the surface oxide layer: more than 15 μm and less than 57 μm, (C) the thickness of the inner oxide layer: more than 33 μm and less than 80 μm, and (D) the total thickness: more than 48 μm and less than 90 μm. Electrode materials having a specific oxide film satisfying at least one of (A) to (D) after the high temperature oxidation treatment were resistant to corrosion by corrosive liquids as shown in Table III. Thus, electrode materials or electrodes having an oxide film satisfying at least one of (A) to (D) formed in advance by oxidation treatment are resistant to corrosion. The retention time of the oxidation treatment in this test was 24 hours, which is shorter than the time to form an oxide film in the high-temperature oxidation test. Thus, even examples including the formation of such an oxide film have high productivity.

The samples No. 1 to No. 11 had a specific resistance as low as 25 μΩ·cm or less.

This is probably partly because the Al, Si, and Cr contents are not excessive. In particular, a lower Cr content tends to result in a lower specific resistance. Because of their low specific resistance, the samples No. 1 to No. 11 suffered from less erosion due to the impulse and were resistance to spark erosion. In addition, the samples No. 1 to No. 11 rarely had compound particles.

This is probably partly because the inclusion of Al, Si, Cr, and optionally Mn prevented the elements in the atmosphere and Ni in the alloy main phase from forming a compound having a low melting point.

The samples No. 101 to No. 106, which did not have the specific composition, had an excessively thick inner oxide layer because of small amounts of additive elements, a high specific resistance because of large amounts of additive elements, had expansion, cracking, or separation of the oxide film, had an excessive number of compound particles, or were easily corroded by corrosive liquid. Although the sample No. 11 had insignificant expansion and cracking in the high-temperature oxidation test at 1000° C. for 100 H, when an oxide film is formed under the conditions closer to the actual automobile operating mode, the sample No. 11 is expected to be resistant to corrosion as described above and be used without problems.

The test results show that the electrode materials having the specific Al, Si, Cr, Y, Ti, and optional Mn contents and having a Si/Cr ratio of 1 or more were resistant to oxidation at high temperatures, had a low specific resistance, rarely had compound particles, and were resistant to corrosive liquids. Thus, in a spark-plug electrode made of the electrode material or a spark plug including the electrode, an oxide film (particularly an inner oxide layer) is appropriately formed over time. The oxide film thus formed rarely suffers from expansion, cracking, or separation, has high adhesiveness, has a low specific resistance, is resistant to spark erosion, retards the formation and growth of the compound particles, and is resistant to corrosion even by a corrosive liquid formed during operation. An electrode material made of a nickel alloy containing specific amounts of specific elements and having an oxide film satisfying the specific thickness ratio or thickness, a spark-plug electrode manufactured using the electrode material, and a spark plug including the spark-plug electrode having the oxide film are resistant to corrosion by the corrosive liquid over time from the beginning due to the presence of the oxide film. In the spark-plug electrode made of a nickel alloy having the specific composition, the oxide film has good adhesion to the alloy base material of the electrode and is rarely separated from the alloy base material. Also because of this, the spark-plug electrode is resistant to corrosion for a long time from the beginning.

Thus, the spark-plug electrode and the spark plug are expected to operate properly for a long time even at higher temperatures than before (for example, at very high temperatures, such as the existing temperature+approximately 100° C.) or in EGR or idling stop environments. The spark-plug electrode having an oxide film and the spark plug including the electrode are expected to operate properly for a long time from the beginning without performing another process, such as plating.

It is also expected from the test results that in the evaluation of corrosion resistance in the specific corrosion resistance test the multilayer structure and specific state of an oxide film subjected to high-temperature oxidation (preferably 900° C. for 24 hours) are criteria for corrosion resistance, and the corrosion resistance can be precisely determined from the corrosion state after immersion in the specific corrosive liquid.

The conditions for the specific corrosion resistance test can be altered as described below. For example, the heating temperature of the high-temperature oxidation process may be 800° C. or more and 1100° C. or less. A higher heating temperature tends to result in a larger thickness of the oxide film. Since the oxide film having an excessive thickness may block the penetration of a corrosive liquid, the heating temperature is preferably 900° C. or more and 1000° C. or less.

In the case of high-temperature oxidation in the air atmosphere, it is easy to control the atmosphere, and an oxide film can be formed in a short time because of the relatively high oxygen concentration. This shortens the test time and improves workability. A low oxidizing atmosphere having a lower oxygen concentration than the air, for example, an oxygen concentration of 0.01% by volume or more and 20% by volume or less may also be used. In internal combustion engines, such as automotive gasoline engines, the combustion gas atmosphere generally has a lower oxygen concentration than the air (20% by volume or less). Thus, the low oxidizing atmosphere is closer to the actual operating environment. The ambient gases other than oxygen include an inert gas, such as nitrogen, argon, or helium. The gas of the low oxidizing atmosphere may be a mixture of oxygen gas and the inert gas or a mixture of oxygen gas and the air.

The retention time at the heating temperature may be enough time to form an oxide film, for example, one hour or more. In an atmosphere having a constant oxygen concentration, a higher heating temperature or a longer retention time tends to result in a larger thickness of the oxide film. An excessively large thickness of the oxide film may result in insufficient penetration of a corrosive liquid, as described above. Thus, the retention time in the air atmosphere is preferably 1 hour or more and 100 hours or less, more preferably 1 hour or more and 72 hours or less, still more preferably 2 hours or more and 24 hours or less. A lower oxygen concentration tends to result in a longer formation time of the oxide film. Thus, the retention time in the low oxidizing atmosphere is preferably longer than the retention time in the air atmosphere, for example, 2 hours or more and 200 hours or less, more preferably 3 hours or more, still more preferably 10 hours or more and 100 hours or less.

Since the heating temperature, the atmosphere (oxygen concentration), and the retention time are interrelated, one of these conditions is controlled while taking the other conditions into account.

In order to accelerate corrosion as described above, the corrosive liquid used in immersion is preferably an aqueous solution containing chloride ion (Cl⁻), typically aqueous sodium chloride (NaCl). When the NaCl concentration (mass percent) of the aqueous NaCl is 1% or more and 10% or less, NaCl is rarely responsible for corrosion.

The corrosive liquid contains an acid. More specifically, the corrosive liquid preferably contains at least one of nitric acid, sulfuric acid, phosphoric acid, and hydrochloric acid. It is easy to prepare and control the concentration of a single acid. Use of multiple types of acids in combination is expected to more closely simulate the corrosive liquid produced in the actual operating environment.

With respect to the acid concentration, the mass ratio of aqueous NaCl to the acid may range from approximately 50:50 to 99:1, wherein the total mass of the corrosive liquid is 100. In this range, it is expected that sufficient corrosion can be achieved by immersion for a relatively short time (approximately 2 to 48 hours). The temperature of the corrosive liquid may be room temperature (approximately 20° C. to 25° C.). When the temperature of the corrosive liquid ranges from approximately 50° C. to 80° C., this can accelerate corrosion and further shorten the immersion time.

The immersion time depends on the material of the objective to be immersed (electrode material) and the composition (such as the acid concentration and the NaCl concentration) and temperature of the corrosive liquid. When the objective to be immersed is made of a nickel alloy as in an electrode material according to an embodiment of the present invention, the immersion time is suitably approximately 2 hours or more and 48 hours or less.

The present invention is not limited to these embodiments and may be modified within the gist of the present invention. For example, the electrode material may have different compositions, shapes, and sizes. The composition of the ground electrode may be different from the composition of the center electrode.

### INDUSTRIAL APPLICABILITY

An electrode material according to an embodiment of the present invention can be suitably used as a constituent material for spark-plug electrodes of various internal combustion engines, such as engines for automobiles (typically four-wheeled vehicles and two-wheeled vehicles). A spark-plug electrode according to an embodiment of the present invention can be suitably used as a component of the spark plug. A spark plug according to an embodiment of the present invention can be suitably used as an ignition member of the internal combustion engines.

1. An electrode material, comprising, on a mass percent basis:
0.005% or more and 0.2% or less Al;
0.2% or more and 1.6% or less Si;
0.05% or more and 1.0% or less Cr;
0.05% or more and 0.5% or less Ti; and
0.2% or more and 1.0% or less Y, the remainder being Ni and inevitable impurities,
wherein the Si/Cr mass ratio is 1 or more.

2. The electrode material according to claim 1, further comprising 0.05% or more and 0.5% or less Mn on a mass percent basis.

3. The electrode material according to claim 1, wherein the Y content is more than 0.3% on a mass percent basis.

4. The electrode material according to claim 1, further comprising more than 0% and 0.05% or less B on a mass percent basis.

5. The electrode material according to claim 1, wherein the electrode material has a specific resistance of 25 μΩ·cm or less at room temperature.

6. The electrode material according to claim 1, wherein the electrode material heated at 1000° C. for 100 hours has an average grain size of 300 μm or less.

7. The electrode material according to claim 1, wherein the electrode material heated at 900° C. for 24 hours has an oxide film on the surface thereof, and the oxide film has a two-layer structure including an inner oxide layer and a surface oxide layer and satisfies at least one of the following (A) to (D):
(A) the ratio of the thickness of the surface oxide layer to the thickness of the inner oxide layer is more than 16% and less than 173%,
(B) the surface oxide layer has a thickness of more than 15 μm and less than 57 μm,
(C) the inner oxide layer has a thickness of more than 33 μm and less than 80 μm, and
(D) the surface oxide layer and the inner oxide layer have a total thickness of more than 48 μm and less than 90 μm.

8. The electrode material according to claim 1, wherein the electrode material has an oxide film on at least part of the surface thereof, and the oxide film has a two-layer structure including an inner oxide layer and a surface oxide layer and satisfies at least one of the following (A) to (D):
(A) the ratio of the thickness of the surface oxide layer to the thickness of the inner oxide layer is more than 16% and less than 173%,
(B) the surface oxide layer has a thickness of more than 15 μM and less than 57 μm,
(C) the inner oxide layer has a thickness of more than 33 μm and less than 80 μm, and
(D) the surface oxide layer and the inner oxide layer have a total thickness of more than 48 μm and less than 90 μm.

9. A spark-plug electrode, comprising the electrode material according to claim 1.

10. A spark plug, comprising the spark-plug electrode according to claim 9.
